(19) United States
(12) Patent Application Publication
(10) Pub. No.: US 2011/0171617 A1
(43) Pub. Date: Jul. 14, 2011

(54) SYSTEM AND METHOD FOR TEACHING PICTOGRAPHIC LANGUAGES

(75) Inventors: Chan H. Yeh, Los Altos, CA (US); Yong L. Yeh, Foster City, CA (US)

(73) Assignee: Ideographix, Inc., Sunnyvale, CA (US)

(21) Appl. No.: 12/987,904

(22) Filed: Jan. 10, 2011

Related U.S. Application Data
(60) Provisional application No. 61/294,001, filed on Jan. 11, 2010.

(51) Int. Cl. G09B 19/06

(52) U.S. Cl. 434/157

(57) ABSTRACT

In some embodiments, methods and related systems for teaching pictographic languages are disclosed. The touchscreen of a touchscreen keyboard displays the pictographic characters to be learned by a user. The characters can be, e.g., several hundred of the most commonly used characters in that language. The characters are grouped into regions, with each region having characters with similar pronunciations, e.g., a similar first sound. The locations of the regions correspond to the locations of similar sounding letters in a QWERTY keyboard. The characters on the keyboard can be learned one at a time. Region and character selection by a user and/or drills from a learning program allow the user to associate a character with its meaning and usage. Advantageously, the characters and their locations on the keyboard can be standardized, which allows the user to quickly find a character and learn its meaning by a combination of memorization and muscle-memory.

### CROSS-REFERENCE TO RELATED APPLICATIONS

This application claims the priority benefit under 35 U.S.C. §119(e) of U.S. Provisional Patent Application No. 61/294,001, filed on Jan. 11, 2010, the disclosure of which is incorporated herein by reference.

### BACKGROUND

1. Field

This invention relates to systems and related methods for teaching and learning pictographic languages, such as written Chinese, using an electronic input device, such as a touchscreen keyboard.

2. Description of the Related Art

Some languages use a pictographic writing system. These writing systems typically include a large number of characters, each of which may be a word or part of a word and can have a specific phonetic sound. The written Chinese language is an example of a pictographic writing system. It is estimated that about 7,000 or more characters are used by a well-educated Chinese writer and reader.

The number and complexity of the characters in a pictographic language present significant challenges for students of the written language. There is no “alphabet” since individual characters denote a unique word or words. Consequently, each character is learned individually, and its meaning is determined based upon its appearance.

Once the characters are learned, it is often also a challenge to compose written communications. For example, apart from learning grammar, written communication in pictographic graphic languages is further complicated by the lack of an alphabet for these languages. It will be appreciated that much of modern written communication is conducted electronically, e.g., using computer devices. Where a language has an alphabet-based writing system (e.g., English), the language can easily be inputted into the electronic device using the letters of the alphabet. The QWERTY keyboard is one example of an input device for a language having an alphabet-based writing system.

Due to the prevalence of these keyboards, many methods have been devised to use a QWERTY keyboard to input pictographic characters. In general, the methods use particular coding systems in which the user inputs a particular sequence of keystrokes on the QWERTY keyboard and the computer device translates the keystroke sequence into the appropriate pictographic character. Examples of such input methods include “Pinyin,” “Wubi,” “Bopomofo,” “Dayi,” and “Cangjie.” Thus, the student of the language typically must first learn the meanings of pictographic characters and how to write them, and then must learn the coding system for inputting these characters into an electronic device.

As a result of the sheer number of characters in a pictographic language and the coding that must typically be learned to input characters into electronic devices, learning to communicate in a pictographic language can be difficult. Thus, there is an on-going need to provide methods and systems that can effectively teach and facilitate communications in a pictographic language.

### BRIEF DESCRIPTION OF THE DRAWINGS

The invention will be better understood from the Detailed Description of Some Embodiments and from the appended drawings, which are meant to illustrate and not to limit the invention. Like numerals refers to like parts throughout.

FIG. 1 is a schematic diagram of a computer system including a touchscreen input device according to some embodiments of the invention.

FIG. 2 is a block diagram schematically illustrating components of the touchscreen input device of FIG. 1.

FIGS. 3A to 3D are a top plan view, a front view, a left side view, and a right side view, respectively, of the touchscreen input device of FIG. 1.

FIG. 4A illustrates the touchscreen display of the input device of FIG. 1, which displays a homepage according to one embodiment of the invention.

FIG. 4B illustrates the touchscreen display of the input device of FIG. 1, which displays a homepage having background English alphabet letters with color shading according to another embodiment of the invention.

FIG. 4C illustrates the touchscreen display of the input device of FIG. 1, which displays a homepage having background English alphabet letters according to yet another embodiment of the invention.

FIG. 5 illustrates the touchscreen display of the input device of FIG. 1, which displays an additional page having a standard QWERTY layout with Chinese radicals and characters according to yet another embodiment of the invention.

FIG. 6 illustrates the operation of the touchscreen display of the input device of FIG. 1, in which a magnifying window is activated upon touching a character key region according to one embodiment of the invention.

FIG. 7A illustrates the operation of the touchscreen display of the input device of FIG. 1, in which a next character region is activated upon touching a next character region according to one embodiment of the invention.

FIG. 7B illustrates the operation of the touchscreen display of the input device of FIG. 1, in which a next character region is activated upon touching a character on a magnifying window according to another embodiment of the invention.

FIG. 7C illustrates the operation of the touchscreen display of the input device of FIG. 1, in which a next character region is activated upon touching a character on a magnifying window according to yet another embodiment of the invention.

FIG. 7D illustrates the operation of the touchscreen display of the input device of FIG. 1, in which a next character region containing English translation is activated upon touching a character on a magnifying window according to yet another embodiment of the invention.

FIGS. 8A and 8B illustrate the operation of the touchscreen display of the input device of FIG. 1, in which a magnifying window with shortcut buttons to custom pages is activated upon touching one of grids of characters according to one embodiment of the invention.

FIG. 9 illustrates a computer monitor and a standard English keyboard, where the computer monitor displays a software-implemented input device for Chinese characters according to one embodiment of the invention.

FIG. 10 illustrates a computer system for teaching a pictographic language according to one embodiment of the invention.

### DETAILED DESCRIPTION OF SOME EMBODIMENTS

In some embodiments, the teaching of a pictographic language and communications in that language are facilitated by the use of an input device that can display and accept selection of individual pictographic characters. The need for a coding system can be eliminated, while recognition and teaching of the characters of the language is facilitated and simplified.

In some embodiments, the input device includes a display that displays an array of commonly used characters. The characters are grouped in particular regions, with the groupings made, for example, based upon pronunciation of the characters. The regions in turn are organized according to user preferences. In some preferred embodiments, the regions have an arrangement that substantially matches the orientation of letters on a QWERTY keyboard, although not all 26 letters on the QWERTY keyboard may have characters corresponding to the sound of that letter. For example, the characters are grouped so that all those in a group have a similar first phonetic sound and the group is in a region corresponding to the location of a letter for that sound. Letters for which there is no corresponding first phonetic sound in the pictographic language can be omitted.

The input device can include a touchscreen display. The touchscreen display is programmed to display a first arrangement including a first set of characters of the pictographic language. The first arrangement includes a plurality of regions, each of which contains a plurality of complete characters displayed therein. A user can select a character by first selecting the region including that character, to highlight the region, and then selecting the characters in the highlighted region. This configuration provides an input device that can be effectively used by non-speakers and students of the pictographic language as well as native speakers.

It will be appreciated that a well-educated Chinese speaker may recognize 7,000 or more Chinese characters. The government of the People's Republic of China defines literacy as knowledge of at least 2,000 Chinese characters. An understanding of about 800-1,000 characters, however, is believed to allow a person to read a Chinese newspaper. In preferred embodiments, the first arrangement can contain about 800-840 of the most commonly used Chinese characters. These characters allow the user to directly input characters to, for example, perform basic written communications, such as e-mail. Additional characters can be provided in additional arrangements by refreshing the arrangement displayed on the touchscreen display.

Advantageously, where a user has some familiarity with a pictographic language, the input device can facilitate the teaching of the language simply by repeated usage of the device and the association of a particular region and key with a particular character. In addition, the input device can be used with more structured teaching programs. These programs include “active” and “traditional” methods.

For example, in the active method, a user actively selects a region and character. This selection causes information about that character to be displayed, including, without limitation, the meaning or translation of the character, its pinyin spelling, an option to hear the character pronounced, the form of speech of the character, the variations in the form of speech (e.g., noun, verb, etc), the most common usages of the character in phrases or sentences, and an image of the object denoted by the word if applicable. The information about the character can be displayed in the user's native language, or other language understood by the user.

In the traditional method, the user can follow a lesson plan that teaches them particular characters in a particular order. For example, the user can be taught characters one phonetic group at a time; one region at a time; in conjunction with common conversational phrases; and by subject matter. Information regarding the character being taught can be displayed. This information can be same as the information noted above in discussing the active method.

As discussed above, in practice, many of the existing methods for electronically inputting pictographic characters essentially require a user to learn a system for coding the pictographic characters using the keys of a keyboard. A computer then decodes the “coded” keystrokes to display the desired character. Thus, the existing methods require a language student to first learn the characters of the language and then learn the “coding” system used by that language in order to input characters electronically. Advantageously, preferred embodiments of the invention provide efficient systems and methods that remove the intermediate coding and decoding step, thereby allowing a user to more quickly communicate via the written pictographic language. Moreover, learning to handwrite the characters would be optional. Visual familiarity with the characters is sufficient for students to input the characters into an electronic device and allow written communication. Preferably, the characters are provided on a keyboard having a standardized layout between different ones of that keyboard. Thus, a user could learn to write in the pictographic language by generally knowing the appearance of characters and by muscle-memory, since the characters are located at standardized locations. Advantageously, barriers to written communication for students of the pictographic language are reduced.

Reference will now be made to the Figures, in which like numerals refer to like parts throughout.

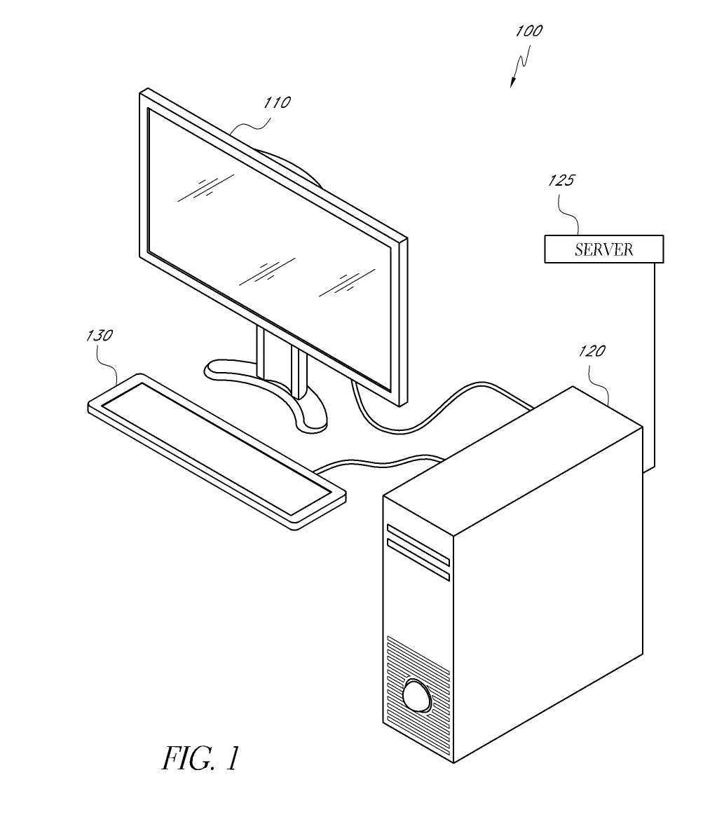

Referring to FIG. 1, a computer system 100 for inputting a pictographic language according to some embodiments will be described below. The pictographic language can be written Chinese. In other embodiments, the pictographic language can be any other pictographic language, including, without limitation, Japanese Kanji and Korean Hanja. The illustrated computer system 100 includes a display device 110, a computer 120, and an input device 130. The computer 120 can be connected to a server 125 in some embodiments.

The display device 110 serves to provide a visual interface with a user. The display device 110 can display graphics, images, and/or characters, depending on the software program running on the computer 120. The display device 110 can be any suitable display device, for example, an LCD display or a CRT display.

The computer 120 serves to store software programs and provide operations according to commands provided by the software programs. The computer 120 can be any suitable general purpose computer, or a computer specifically adapted for the system 100. The computer 120 can include a CPU, one or more volatile and non-volatile memories, a hard disk drive, and any other components required for the operation of a computer, as known in the art. The computer 120 can operate on any suitable operating system, for example, any version of Microsoft Windows®, Linux®, or Mac OS®.

In some embodiments, the computer 120 can be connected to the server 125. The server 125 can be connected to the computer 120 as part of a local area network, or via the internet. The server 125 can also be connected to multiple display devices 110 and input devices 130.

With continued reference to FIG. 1, the input device 130 serves as a keyboard and provides an interface for a user to input commands, characters, and/or numbers for the operation of the computer 120. The input device 130 is preferably a touchscreen display device that can display graphics, images, and/or characters while receiving inputs by touches of a user. Details of the input device 130 are described further herein.

In the illustrated embodiment, the display device 110, the computer 120, and the input device 130 are separated from one another. In other embodiments, however, two or more of the display device 110, the computer 120, and the input device 130 can be integrated with one another. In other embodiments, one or more of the display device 110, the computer 120, and the input device 130 can be implemented in a single housing, for example, the form of a laptop computer or a display device having a touchscreen (thereby combining devices 110 and 130 or all of devices 110, 120, and 130).

In embodiments, the input device 130 can be connected via, for example, a USB port, for example, to a laptop computer, which already has a conventional keyboard, such as a QWERTY keyboard. In the context of this document, a laptop computer refers to any portable computer, including, but not limited to, a conventional laptop computer, a netbook, and a hand-held computer. In some embodiments, the input device 130 can be connected to any electronic device with computing capability, for example, a mobile phone, a smart phone, a digital video/audio player (for example, iPod®), a telephone with a screen, a television, a digital book device, a personal digital assistant (PDA), a facsimile machine with a screen, a scanner with a screen, a multi functional peripheral device with a screen, and the like. These devices can include a memory and a processor functioning as the computer 120, along with a display functioning as the display device 110.

In certain embodiments, a touchscreen mobile computing device, such as a tablet computer (for example, Samsung Galaxy Tab®) or a smart phone, can serve as a combination of the display device 110, the computer 120, and the input device 130. The mobile computing device can run on any suitable operating system (for example, Google Android®). In such embodiments, the mobile computing device can be connected (wirelessly or by wire) to the display device 110 (which can be, for example, a TV or monitor). In other embodiments, a portion of the touchscreen of the mobile computing device can be used as the input device 130, and another portion of the touchscreen can be used as the display device 110.

The input device 130 and related software which will be described herein can be implemented as an application program or an “app.” The app can be opened by touching an icon on the touchscreen of the mobile computing device during normal operation. The app can be stored in a server (for example, an app store), and can be downloaded to individual mobile computing devices.

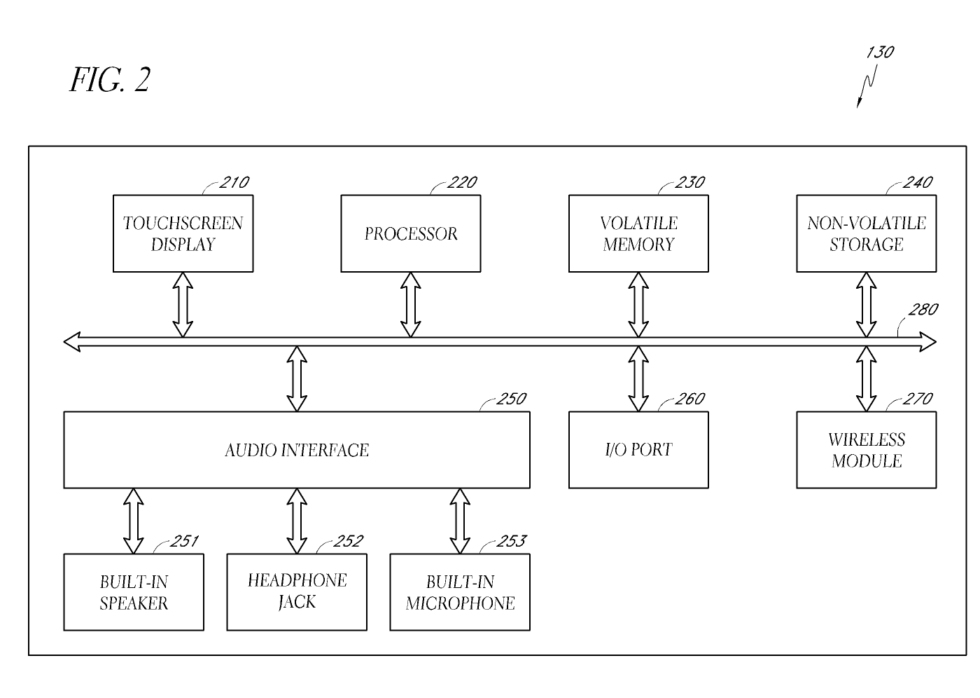

Referring to FIG. 2, one embodiment of the input device 130 of FIG. 1 is schematically illustrated. The illustrated input device 130 includes a touchscreen display 210, a processor 220, a volatile memory 230, a non-volatile storage 240, an audio interface 250, an input/output (I/O) port 260, and a wireless module 270 that are in data communication with one another via a data bus 280. The processor 220 and non-volatile storage 240 constitute a controller for controlling the touchscreen display 210. The input device 130 can include any other components that are needed for the operation of the input device 130. In other embodiments, one or more (for example, the wireless module 270) of the above-mentioned components can be omitted. In some other embodiments, various components, for example, the controller and memory can be located physically separated from the input device 130, or can be omitted altogether.

The touchscreen display 210 serves as both an input device and a display device. In some embodiments, the touchscreen display 210 can be a liquid crystal display (LCD). The touchscreen display 210 can have multi-touch capability and a back light. It will be appreciated that other display technologies known in the art and allowing touch-sensitive operation may also be used.

The processor 220 serves to perform and control operations of the input device 130 according to a software program and/or user commands. The processor 220 can be a processor or microprocessor of any suitable type.

The volatile memory 230 can be a random access memory (RAM) of any suitable type and capacity. The non-volatile storage 240 can be a read only memory (ROM) of any suitable type and capacity. The non-volatile storage 240 can also include one or more of a hard disk and a flash memory. In some embodiments, the non-volatile storage 240 can store various commands and software programs for operating the input device 130. Programming stored in the input device 130 can allow the device 130 to achieve the display screens and functionality described herein for operation of the device 130. It will be appreciated that programming to achieve the displays and functionality herein described can be provided to a user as a permanent part of the input device 130, or can be loaded into a general purpose touchscreen device from a server or connected computer, which loading can allow the programming and resulting functionality of the device 130 to be loaded onto the device 130.

The audio interface 250 serves to provide an interface for audio data communication with an external device and built-in audio devices. The audio interface 250 can be connected to one or more of a built-in speaker 251, a headphone jack 252, and a built-in microphone 253. The audio interface 250 can also provide one or more ports that can be connected to an external speaker and/or microphone.

The I/O port 260 serves as a port for data communication with an external device, such as the display device 110 and/or the computer 120 of FIG. 1, or any other peripheral devices, for example, a mouse and a conventional keyboard. In one embodiment, the I/O port 260 can include one or more universal serial bus (USB) ports and/or one or more parallel or serial ports. In some embodiments, the I/O port 260 can be used for downloading additional fonts, characters, configurations, and/or updates for the input device 130 from a data source, including, but not limited to, the computer 120. Such a data source can be a server or another computer that can be connected to the input device 130 over the Internet or LAN, or via a local, standalone computer 120 of the system 100.

In some embodiments, in addition to, or instead of a wired connection, the wireless module 270 serves to provide a wireless connection with an external device, such as the display device 110 and/or the computer 120 of FIG. 1. The wireless module 270 can also provide a wireless connection with any other electronic device having wireless capability. The wireless module 270 can be a wireless chip and transmitter and antenna that can operate in any suitable wireless network, for example, Wireless LAN (WLAN). The wireless chip can operate in compliance with any suitable wireless protocol, for example, IEEE 802.11 (for example, Wi-Fi®) or Bluetooth®.

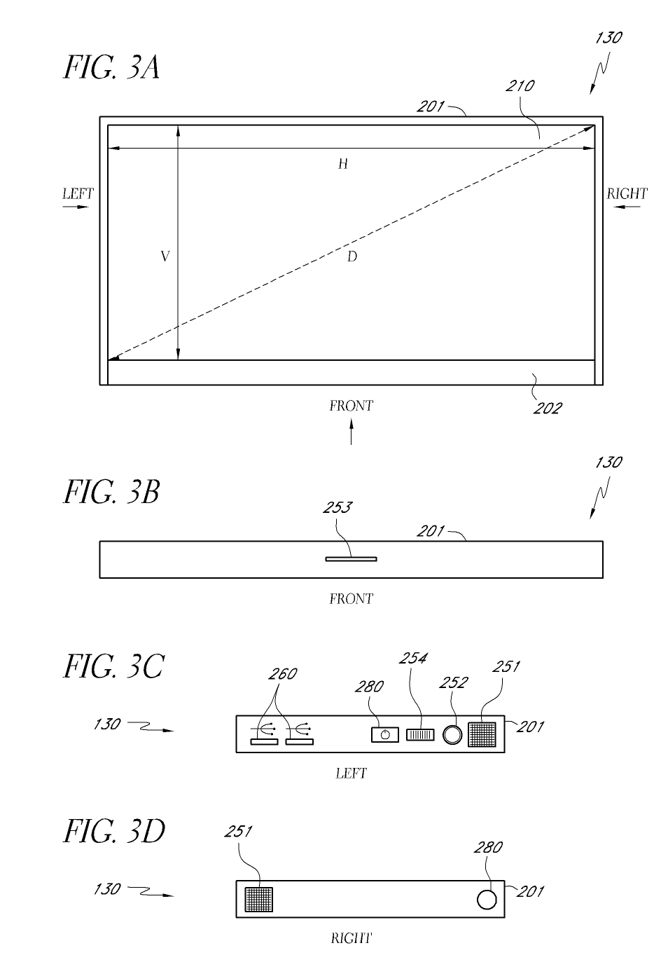

Referring to FIGS. 3A-3D, an external appearance of the input device 130 according to one embodiment is illustrated. A top plan view of the input device 130 is shown in FIG. 3A. When viewed from above, the input device 130 includes a housing 201, an optional pad 202, and a touchscreen display 210. The housing 201 may have a rectangular shape or other arbitrary shape, and can be formed of any suitable material, such as a plastic or metallic material. The pad 202 is positioned along the bottom side of the housing 201 when viewed from above. The pad 202 is configured to provide ergonomic comfort to a user's wrist or hand, and can be formed of memory foam or rubber or other comparable material.

The input device 130 can be formed of a suitable size for desired applications. For example, in some embodiments, when viewed from above, the touchscreen display 210 can have a horizontal length H ranging from about 11.5 inches to about 12.5 inches, and a vertical length V ranging from about 5.5 inches and to about 6.5 inches. In one embodiment, when viewed from above, the touchscreen display 210 can have a vertical length V of about 6 inches and a horizontal length H of about 12.5 inches with a diagonal length D of about 13.5 inches, such sizes can have advantages for integration with existing keyboard trays and holders.

On the front surface of the housing 201 of the input device 130, a built-in microphone 253 may be positioned at the center of the front surface, as shown in FIG. 3B. On the left side surface of the housing 201 of the input device 130 are USB ports 260, a power switch 280, a volume controller 254, a headphone jack 252, and a built-in speaker 251, as shown in FIG. 3C. On the right side surface of the housing 201 of the input device 130 are another built-in speaker 251 and a stylus housing hole 280, as shown in FIG. 3D. The stylus housing hole 280 is configured to provide storage for a stylus, details of which will be described later. A skilled artisan will appreciate that the positions of the above-mentioned components can vary widely depending on the design of the input device 130. Moreover, one or more of the components can be omitted or duplicated as desired.

In some embodiments, the input device 130 can have an embedded voice recognition software program to help the selection and teaching of characters. The built-in microphone 253 (FIGS. 2 and 3B) can be used by a user to speak, a word or character or to provide the first phonetic sound of a character or word to the input device 130. The input device 130, upon recognizing the character or word or sound, can highlight the character or word or appropriate region on the touchscreen display 210. In another embodiment, the recognized character can blink. In yet another embodiment, when a word is recognized, the input device 130 can display characters constituting the word simultaneously or sequentially. In certain embodiments, when a particular character displayed on a monitor (for example, the display 110 of FIG. 1) is selected by using, for example, a mouse, the corresponding character on the touchscreen display 210 can light up or blink.

In other embodiments, the input device 130 can provide the pronunciation of a selected character or word upon the user's request or by default. The built-in speaker 251 or the headphone jack 252 can be used to provide such pronunciation.

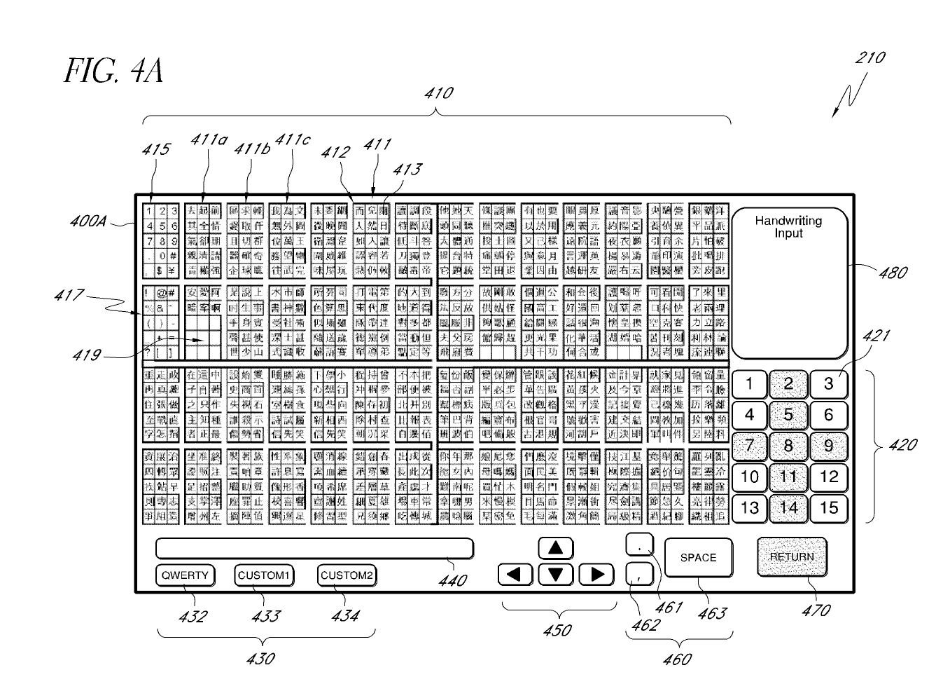

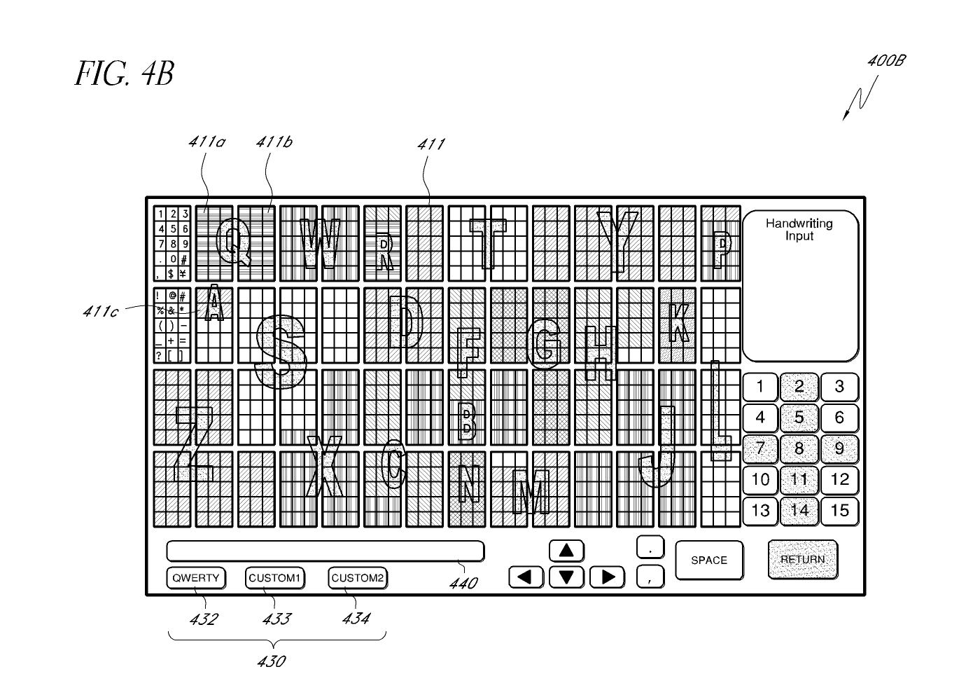

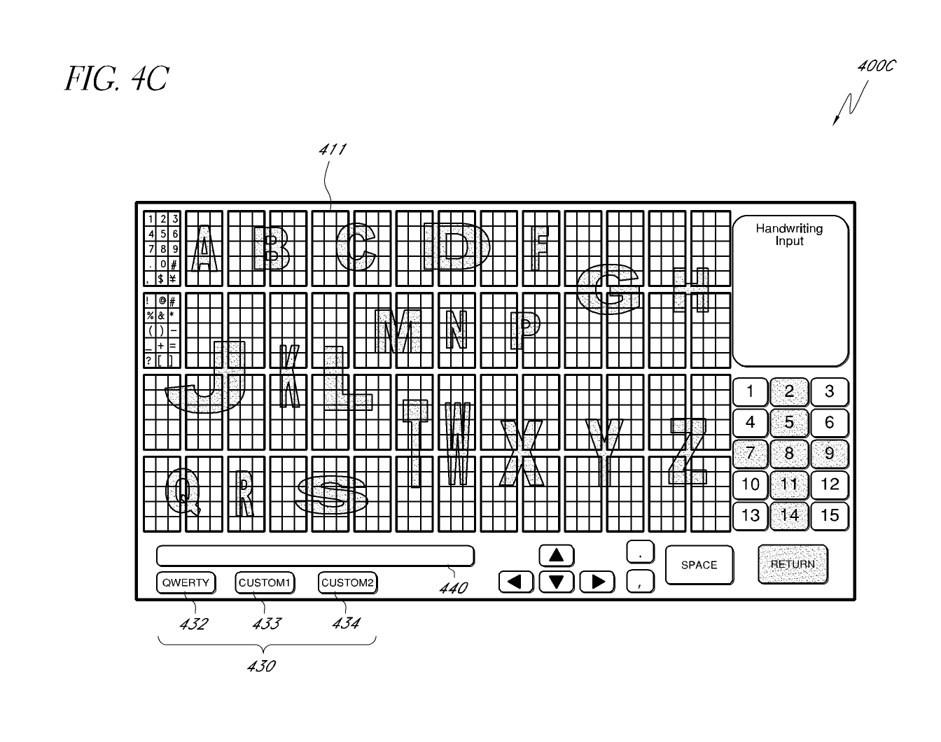

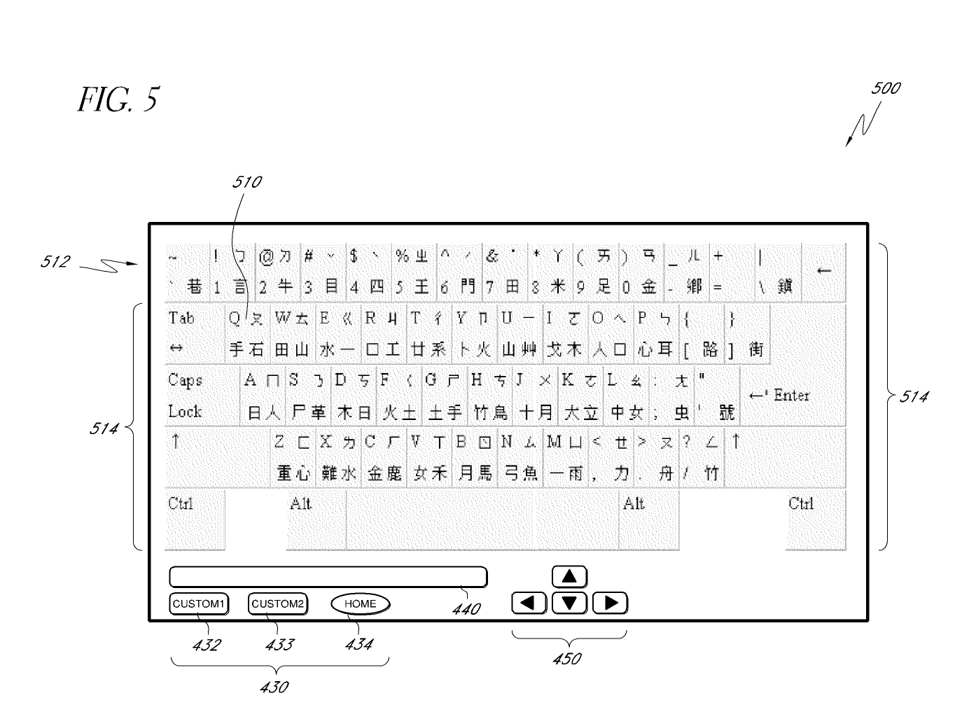

Referring to FIG. 4A, one embodiment of a homepage of the input device 130 is illustrated. The touchscreen display 210 of the input device 130 can display a homepage or initial page 400A, as shown in FIG. 4A. Although not illustrated in FIG. 4A, the touchscreen display 210 can also display additional default pages, customized, pages, and/or a replica QWERTY keyboard, as described further herein.

In the illustrated embodiment, the homepage 400A of the touchscreen display 210 displays an array 410 of key regions 411, 415, 417, 419, a selection pad 420, page selection buttons 430, a next character selection region 440, directional buttons 450, punctuation keys 460, a return key 470, and a stylus pad (or handwriting pad) 480. Although not shown, the homepage 400A can also be programmed to display other menus and/or functional keys, for example, “Tab,” “Ctrl,” “Alt,” “Shift,” “Delete,” “Caps Lock,” “Backspace,” and the like.

The array 410 of key regions includes a plurality of key regions that are generally arranged in a matrix form. In the illustrated embodiment, the array 410 includes 14 columns and 4 rows of key regions. In other embodiments, the numbers of rows and columns can vary from that illustrated, depending on the design of the homepage 400A.

The array 410 includes a plurality of character key regions 411, a numeric and symbol key region 415, a special character key region 417, and a blank key region 419. The numeric and symbol key region 415, the special character key region 417, and the blank key region 419 are positioned at the leftmost side in the array 410. A skilled artisan will, however, appreciate that each of the numeric and symbol key region 415, the special character key region 417, and the blank key region 419 can be positioned at other positions or omitted as desired, depending on the desired design of the homepage 400A.

Each of the key regions 411, 415, 417, 419 can include a grid 412 including cells 413 arranged in a matrix foist. In the illustrated embodiment, each of the key regions 411, 415, 417, 419 is in the shape of a box and includes 3 columns and 5 rows of cells. A skilled artisan will, however, appreciate that the number and arrangement of the cells in each of the key regions 411 can vary from that illustrated, depending on the design of the homepage 400A. In another embodiment, at least one of the key regions 411 can show an array of characters, symbols, and/or numbers in a matrix form without including a grid. It will be appreciated that the illustrated matrix, with its 3×5 grid, has various advantages in operation, as discussed herein.

Each of the character key regions 411 can contain Chinese characters in the cells thereof. Each of the cells of the character key regions 411 can contain a single Chinese character. Details of the character key regions 411 are described further herein.

The numeric and symbol key region 415 can contain numbers from 0 to 9, and various symbols (for example, “$” and “#”). The special character key region 417 can contain various special characters and punctuation marks, such as “!”, “@,” “%,” and the like.

The blank key region 419 can contain characters selected by a user. In certain embodiments, a word of two or more characters can be placed in a cell of the blank key region 419. For example, a user's commonly used words (for example, names, places, and technical terms) can be placed in the cells of the blank key region 419. The placement may be made by the user, who can select characters, or the characters can be selected automatically, for example, using a program that keeps track of, selects, and displays words commonly used by the user.

In the illustrated embodiment in which the homepage 400A is designed for inputting Chinese characters, the character key regions 411 on the homepage 400A display Chinese characters. The Chinese characters in the character key regions 411 can be displayed in traditional form. In some embodiments, the Chinese characters can be optionally displayed in simplified form. For example, a character representing a horse, [symbol] (traditional form), can be optionally displayed in its simplified form, [symbol] In some embodiments, the user can select between simplified or traditional characters as desired.

The Chinese characters shown on the homepage 400A can be selected from commonly used characters, for example, about 800-840 of the most commonly used Chinese characters. In the context of this document, such commonly used characters can be referred to as “homepage characters.”

In some embodiments, each of the character key regions 411 can include Chinese characters having the same or similar phonetic sounds, preferably the same or similar first phonetic sound. As used herein, it will be appreciated that the first phonetic sound refers to the phonetic sound in a desired version or dialect of spoken Chinese, for example, Mandarin or Cantonese. In some preferred embodiments, the first phonetic sound is the first phonetic sound for the word in Mandarin. In the illustrated embodiment, substantially all of the characters in each of the character key regions 411 have the same first phonetic sound. In such an embodiment, the character key regions 411 can be arranged such that the phonetic sounds of the characters in the regions 411 correspond to the location of keys for similar sounding letters in a conventional Roman (or English) alphabet keyboard layout, for example, the QWERTY keyboard layout. For example, a first character key region 411a at a first row and a first column can have characters having a first phonetic sound corresponding to the phonetic sound associated with the letter “Q”, that is, the sound of “Q”. A second character key region 411b at the first row and a second column can have characters having a first phonetic sound of “W.” A third character key region 411c at the first row and a third column can have characters having the first phonetic sound of “E.” In other embodiments, the conventional Roman character keyboard layout can be a Dvorak keyboard layout, a QWERTZ keyboard layout, or an AZERTY keyboard layout with the location of character key regions 411 corresponding to the location of letters, of corresponding phonetic sounds, in these keyboard layouts. In the illustrated embodiments, within each unique key region 411, the Chinese characters are arranged based on their frequency of use within both written and spoken Mandarin with the most frequently used characters in the first row descending to the least frequently used characters in the fifth row.

In certain embodiments, for example, due to the lack of words with a particular phonetic sound, the array 410 may not have a character key region for a certain phonetic sound although the QWERTY layout has a key for the letter with that phonetic sound. For example, the array 410 may not have a character key region for characters having a phonetic sound of “V,” which is present in the QWERTY layout. However, the order and general relative spatial arrangement of the character key regions 411 generally correspond to the order and arrangement of keys of the QWERTY or other keyboard layout onto which the regions 411 may be mapped.

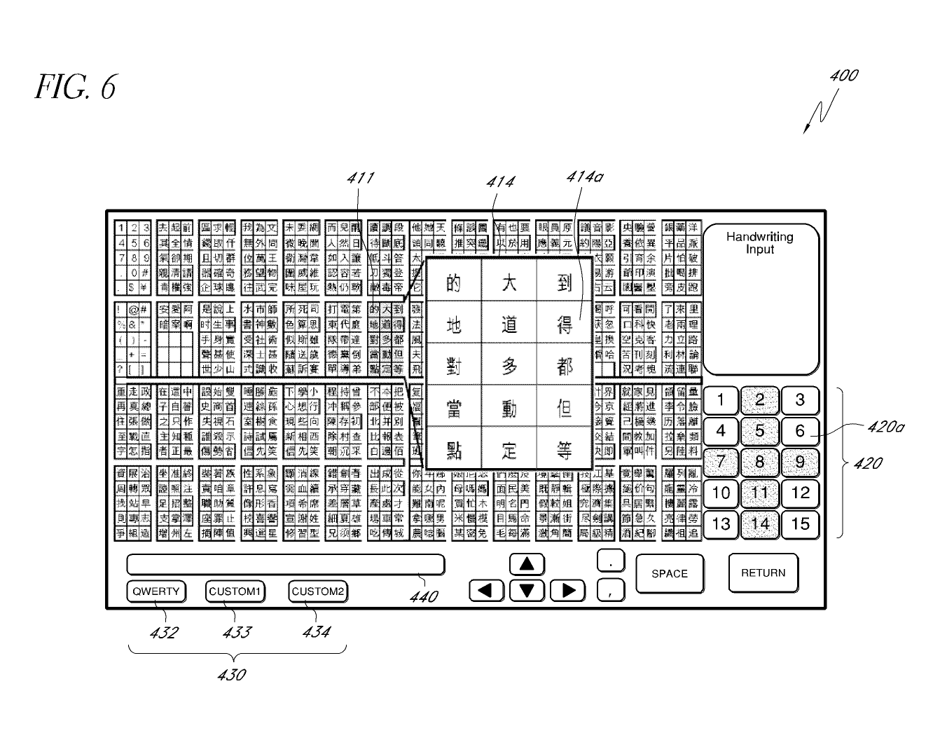

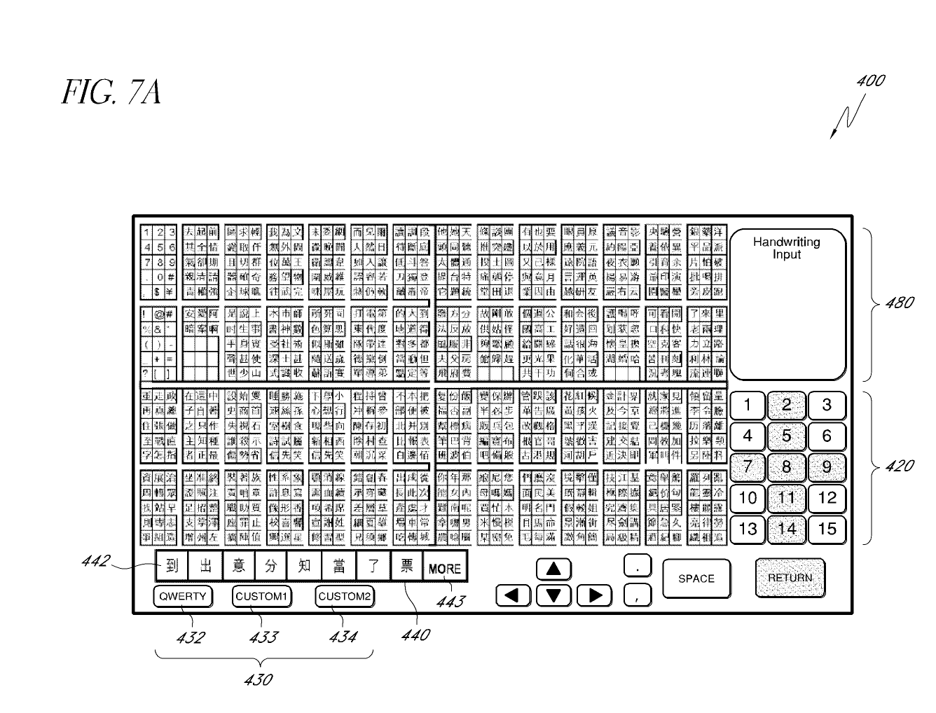

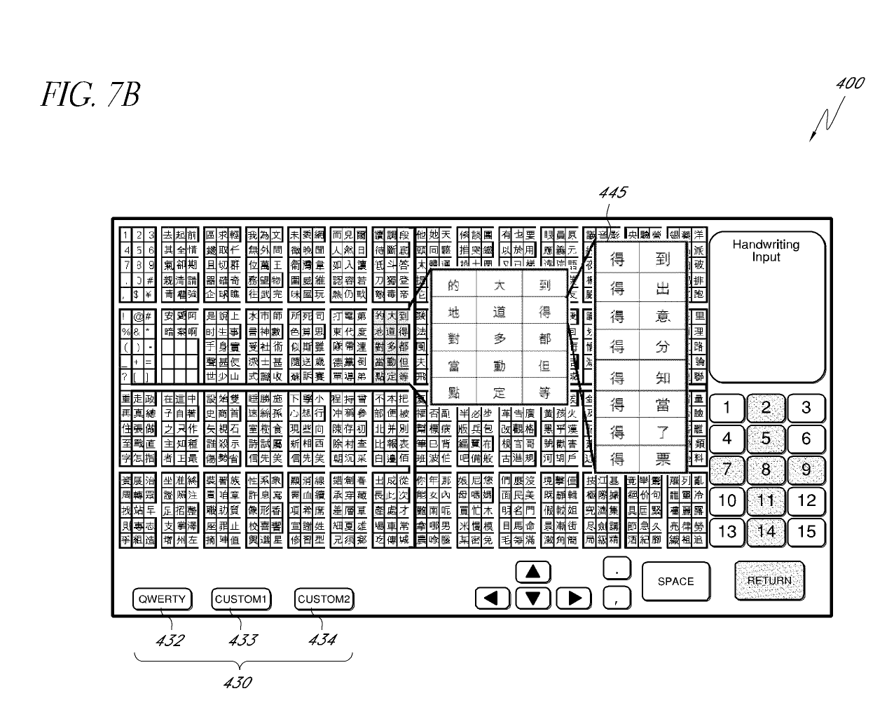

Referring again to FIG. 4A, the selection pad 420 of the homepage 400A includes fifteen numeric selection keys 421 arranged in a matrix form. The numeric selection keys include numbers from 1 to 15 in 5 rows and 3 columns. The arrangement of the numeric selection keys corresponds to the arrangement of characters in each of the character key regions 411. In the illustrated embodiment, each of the character key regions 411 has a 3×5 arrangement, and thus the selection pad 420 also has the 3×5 arrangement. In other embodiments where each of the character key regions on the touchscreen display has a different arrangement (for example, 4×5), the selection pad also has that different arrangement (for example, 4×5). The operation of the selection pad 420 is further described in connection with FIG. 6.

The page selection buttons 430 allow a user to select one of the additional pages that may be programmed into and are displayable by the touchscreen display 210 (FIGS. 2 and 3). The additional pages can include one or more additional default character pages, a replica English (for example, QWERTY) keyboard page, and/or one or more custom pages. In the illustrated embodiment, the page selection buttons 430 of the homepage 400A includes a QWERTY page button 431, a first custom page button 432, and a second custom page button 433, which allow the user to select a replica QWERTY page, a first custom page, and a second custom page, respectively. Some additional details of the additional pages are described in connection with FIG. 5.

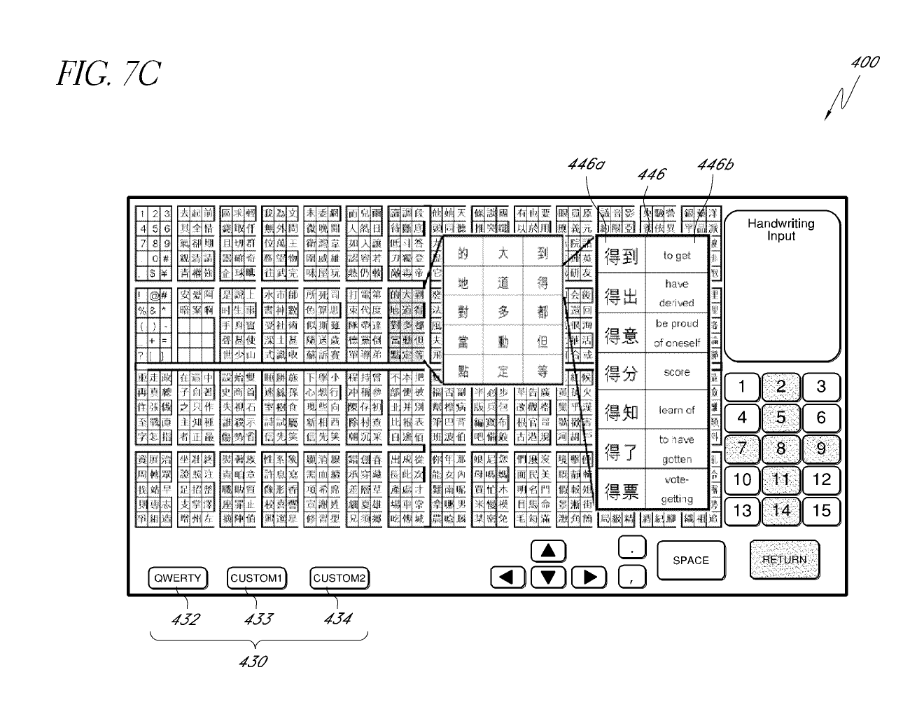

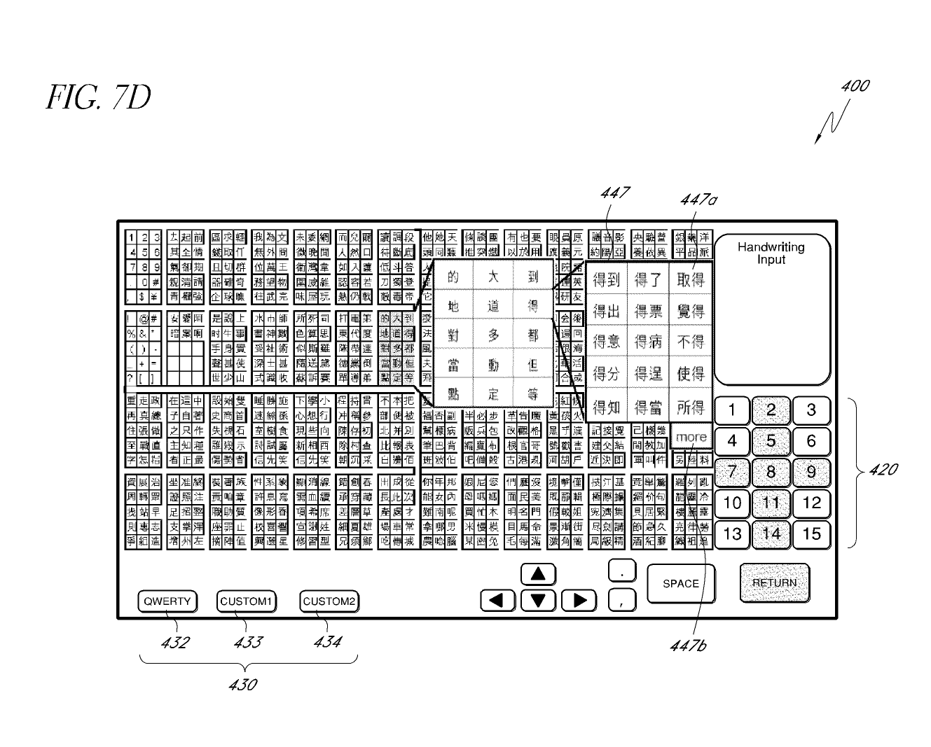

The next character region 440 serves to allow a user to select one of the characters that may commonly follow an already selected character. Details of the operation using the next character region 440 are further described in connection with FIG. 7A.

The directional buttons 450 serve to allow the user to move a cursor to a desired location on the screen of the display device (for example, the display device 110 of FIG. 1). The punctuation keys 460 allow the user to use desired punctuation marks, such as “comma (,),” “period (.),” and “space.” The return key 470 allows the user to execute a command, or move to a next line on the display device's screen.

The stylus pad 480 serves to allow a user to handwrite a character using a stylus, which may be an electronic pen, or the user's finger, or other object. The stylus pad 480 can be used for writing, for example, uncommon words, pronouns, and names. The stylus pad 480 can also be used when the user knows a character, but is unable to locate the character on the character key regions 411. Any suitable stylus technology can be adapted for the stylus pad 480.

In certain embodiments, the touchscreen display 210 (FIGS. 2 and 3A) can have small bumps (not shown) protruding from the top surface of the touchscreen display 210. The small bumps can be positioned to provide locations of certain character key regions by tactile feel. For example, the touchscreen display 210 can have a bump at a position where a character key region for characters having a phonetic sound of “J” is located. The bumps allow the user to easily and consistently orient their hands over the touchscreen display 210.

Referring now to FIG. 4B, a homepage 400B of the touchscreen display 210 according to another embodiment is illustrated. In the illustrated embodiment, characters are omitted for the sake of simplicity of explanation. The homepage 400B can have a background color layer, as shown in FIG. 4B by different shading or hatching. The background color layer can include regions of different colors representing different phonetic sounds. The colors are selected and adjusted so that the colors do not disrupt the user's ability to see characters in the character key regions 411. For example, the colored regions are “transparent” to the characters. In another embodiment, the background color layer can have different grayscales, in combination with or instead of, different colors.

Each of the colors used for the background color layer can be assigned to one or more of the character key regions 411 and/or a portion of one of the character key regions 411. For example, a first character key region 411a at a first row and a first column, and a second character key region 411b at the first row and a second column can have characters having the same first phonetic sound of “Q.” In such an instance, the first and second character key regions 411a, 411b can have the same background shading or color, for example, yellow.

In some embodiments, at least one of the character key regions 411 can contain two or more groups of characters having different phonetic sounds from one group to another. For example, among 15 characters in a character key region 411, characters on the first and second rows in the region 411 can have “J” sound, whereas characters on the third to fifth rows can have “M” sound. Such a character key region can have two different colors for the groups of characters according to their phonetic sounds. For example, a third character key region 411c at a second row and the first column can have two different colors. The first two rows in the region 411c can be in, for example, pink, and the other rows in the region 411c can be in, for example, green.

In certain embodiments, in addition to the background color layer, phonetic characters (for example, English alphabet letters) corresponding to the phonetic sounds represented by the background colors are also provided, as shown in FIG. 4B. In one embodiment, the English letters can lie behind Chinese characters in the character key regions 411. The English letters can also extend over two or more of the character key regions 411.

Referring to FIG. 4C, a homepage 400C of the touchscreen display 210 according to yet another embodiment will be described below. In the illustrated embodiment, each of the character key regions 411 can include Chinese characters having the same or similar first phonetic sound. The character key regions 411 can be arranged such that the phonetic sounds of the characters in the regions 411 are in alphabetical order, as determined by the English alphabet. Other details of the homepage 400C can be described earlier with respect to the homepage 400A of FIG. 4A. In addition, the homepage 400C can also have a background color or shading layer and/or English letters as described herein.

In one embodiment, the touchscreen display 210 of FIGS. 2 and 3A can also display a replica QWERTY keyboard 500, as shown in FIG. 5, when the user touches the QWERTY page button 431 on the homepage 400A of FIG. 4A. The replica QWERTY keyboard 500 can include English alphabet letter keys 510 arranged in the QWERTY layout, number and symbol keys 512, and other functional keys 514, such as “Tab,” “Ctrl,” “Alt,” “Shift,” “Delete,” “Caps Lock,” “Backspace,” and “Enter.” The replica QWERTY keyboard 500 can also show Chinese roots or radicals that are used for other conventional Chinese input systems, such as Wubi, Cangjie, or Bopomofo. This configuration allows a user to use such conventional Chinese input systems with the input device.

The replica QWERTY keyboard 500 can also include page selection buttons 430, a next character selection region 440, and directional buttons 450. The page selection buttons 430 allow a user to access one of other pages, including the homepage 400A of FIG. 4A, the first custom page, and the second custom page. Details of the next character selection region 440 are described further below. Details of the directional buttons 450 can be as described above with respect to the directional buttons 450 of the homepage 400A.

In some embodiments, the touchscreen display 210 of the input device 130 (FIG. 3A) can also display two or more custom pages. In the illustrated embodiments, the touchscreen display 210 can display first and second custom pages. Each of the first and second custom pages can contain additional Chinese characters that are not shown on the homepage 400A of FIG. 4A. The configurations of the first and second custom pages can be the same as described above with respect to the homepage 400A of FIG. 4A except that the custom pages can display characters selected by the user.

In some embodiments, the touchscreen display 210 can also display one or more additional default pages for characters that are less commonly used than the homepage characters. For example, a second page can display less commonly used characters and a third page can display characters that are even more less common. In other embodiments, the touchscreen display 210 can also display one or more additional pages for characters for specific usages or industries, such as a page for characters used in, for example, financial, medical, legal, scientific, or engineering fields.

In preferred embodiments, the layout and/or arrangement of the homepage is standardized and is not changeable by the user, although the layout and/or arrangement of each of the additional pages may be customized by the user. For example, each of the additional pages can be customized to have a different number and arrangement of characters. In other embodiments, one or more of the additional pages may also be standardized and not changeable by the use. Advantageously, a standardized homepage (and standardized additional pages in some embodiments) allows users to quickly transition from using one input device 130 to another input device 130, since the positions and arrangement of characters on the keyboard will remain the same between input devices 130.

However, as the characters and the arrangement of the homepage is preferably determined based on programming, it will be appreciated that the homepage may be easily modified in some applications. For example, different homepages may be generated for different industries or businesses based, e.g., on the commonly used words in those contexts. In other embodiments, the homepage may optionally be customized by the user to, e.g., change the position and identity of characters. Additionally, the input device 130 may provide an option to display a customized homepage for the regular user of that input device and a standard homepage, e.g., for a user that does not regularly use that particular input device.

In addition, the pages can also be adjusted to be left- or right-hand compatible. For example, the selection pad 420 and the stylus pad 480 can be moved to the left side for a left-handed user. Further, in some embodiments, the character key regions 411 can be ergonomically arranged to prevent users from having health issues. For example, the regions 411 can be angled towards a user's left and right hands, respectively. In some embodiments, the font size and style of characters displayed by the touchscreen display 210 can also be changed. Various fonts can be downloaded from a data source, such as a server, accessed, for example, on an internet website.

In some embodiments, the homepage and the additional pages can have different background colors from one another, or be shaded differently so that a user can readily identify which page the user is currently using. For example, the homepage can have a shade of red, while the first custom page has a shade of yellow or other color and/or graphical indication to show that the user is on a different page.

Referring to FIG. 6, a method of inputting a character using the input device 130 described above in connection with FIGS. 1-5 will be described. The method will be described with an example of inputting characters, using the homepage described above in connection with FIGS. 4A-4C. However, the same method can be used with any of the additional pages described herein.

As described above, characters are positioned in the character key regions 411 arranged corresponding to the QWERTY layout. Thus, a user who is aware of the first phonetic sound of a desired character can locate one or more character key regions 411 that may contain the character, based on the background color layer and/or the letters lying behind the character key regions 411. Then, the user can look for the character within the located character key regions 411.

Once the user has found the character, he or she can touch the character key region that contains the character. When the character key region is touched, a magnifying window 414 appears on the touchscreen display 210, as shown in FIG. 6. The user can select the character by touching the character on the magnifying window 414. For example, the user can select a character [symbol] (having a meaning, or translation, of “to obtain”) by touching a cell 414a containing the character [symbol] In another embodiment, the selected key region 411 can also highlight or blink upon being touched.

The magnifying window 414 can disappear upon a second touch on the same character key region 411, or if a character is selected from the magnifying window 414. In some embodiments, the magnifying window 414 can automatically disappear if there is no selection of a character within a selected period of time, for example, about 3 seconds to about 5 seconds. In other embodiments, if the user desires to select more than one character from a particular character key region 411, the user can continue to touch down the character key region 411 with a finger to keep the magnifying window 414 from disappearing.

Alternatively, the user can select the desired character using the selection pad 420. As described above, the selection pad 420 includes selection keys arranged corresponding to the cells of a character key region 411. Because the magnifying window 414 has the same layout as that of the character key region 411, the selection pad 420 also has the same layout as the magnifying window 414. A user can determine the corresponding location of the character on the selection pad 420 by comparing the magnifying window 414 with the selection pad 420. For example, in FIG. 6, the character [symbol] is at the corresponding location of the number “6” on the selection pad 420. The user can select the character [symbol] by touching the number “6” on the selection pad 420. In some embodiments, a selected key region is highlighted without generating a magnifying window. In such embodiments, a desired character in the selected key region can be selected, only using the selection pad 420. Advantageously, the selection pad 420 allows “two-handed” operation of the input device 130, which can increase the speed of inputting characters. For example, the user's left-hand can be used to select a region while the right hand can quickly select a character in that region by using the selection pad 420.

In some embodiments, to aid the user in, e.g., selecting words formed by plurality of characters or to increase the speed of writing, the input device 130 can provide a list of common and likely next characters or words after a character is inputted. The next character can be a likely character following the selected character, for example, to form a word defined by compound characters. An example of such a word would be the word for “man” ( [symbol] or “nán”). This character would then have the characters for “person” ( [symbol] or “rén”) or “child” ( [symbol] or “háizi”) as an option to select for the likely next character or characters. Alternatively, the next character may be a word that commonly follows another word, as determined by general usage, or by analysis of the user's word choices. In one embodiment, such a list of next characters or words can appear on the screen of a display device (for example, the display device 110 of FIG. 1) with numbers assigned to the characters or words. A user can select one of the next characters by selecting one of the numbers, using the selection pad 420.

Referring to FIG. 7A, a method of selecting a next character according to one embodiment is illustrated. In the illustrated embodiment, after a user selects a character by one of the methods described herein, the next character region 440 automatically displays a list of common and likely next characters or words which appears on the displayed page of the touchscreen display 210. The next character region 440 can assume various orientations including a horizontal row or vertical column, e.g., a horizontal column at the top of the home page or a vertical column between the characters and the handwriting input pad 480. In some embodiments, the next character region 440 can display the next characters in a grid (e.g., a 3×5 grid) corresponding to the keypad 420, to optionally allow next character selection using the keypad 420. The user can touch a desired one of the next characters to select it. If the list does not contain the desired next character, the user can touch a “MORE” button 443 to display one or more additional lists of next characters.

Referring to FIG. 7B, a method of selecting a next character according to another embodiment will be described below. In the illustrated embodiment, a character can be selected by one of the methods described earlier, for example, using a magnifying window 414. In preferred embodiments, upon selection of the character, a next character window 445 can automatically appear as a default, as shown in FIG. 7B, with or without turning off the magnifying window 414. The next character window 445 can contain a list of words that contain the selected character. In another embodiment, the next character window 445 can be generated by touching the desired character for a first duration (for example, about 2 seconds) longer than a second duration (for example, about 0.5 second) required for selecting the character only. In yet another embodiment, the next character window 445 can be generated by double touching the desired character similar to double-clicking with a mouse. The user can select a desired next character by touching it on the next character window 445.

Referring to FIG. 7C, a method of selecting a next character according to yet another embodiment will be described below. In the illustrated embodiment, a character can be selected by one of the methods described earlier. In addition, a next character window 446 can be generated by any of the methods described above in connection with FIGS. 7A and 7B. The next character window 446 contains a list of completed words 446a containing the selected character and their translations 446b in the user's native language. The user can select a desired word by touching it on the next character window 446.

Referring to FIG. 7D, a method of selecting a next character according to yet another embodiment will be described below. In the illustrated embodiment, a character can be selected by one of the methods described earlier. In addition, a next character window 447 can be generated by any of the methods described above in connection with FIGS. 7A and 7B. The next character window 447 contains an array of completed words 447a containing the selected character. The next character window 447 can have the same arrangement as the selection pad 420. The user can select a desired word by touching either the word on the next character window 447 or the corresponding selection key on the selection pad 420. The user can also touch a “MORE” button 447b to display an additional list of completed words containing the selected character.

In the embodiments described herein, each of the additional pages (for example, custom pages) is accessible by touching one of the page selection buttons 430. In some embodiments, characters on the additional pages can be accessed without using the page selection buttons 430.

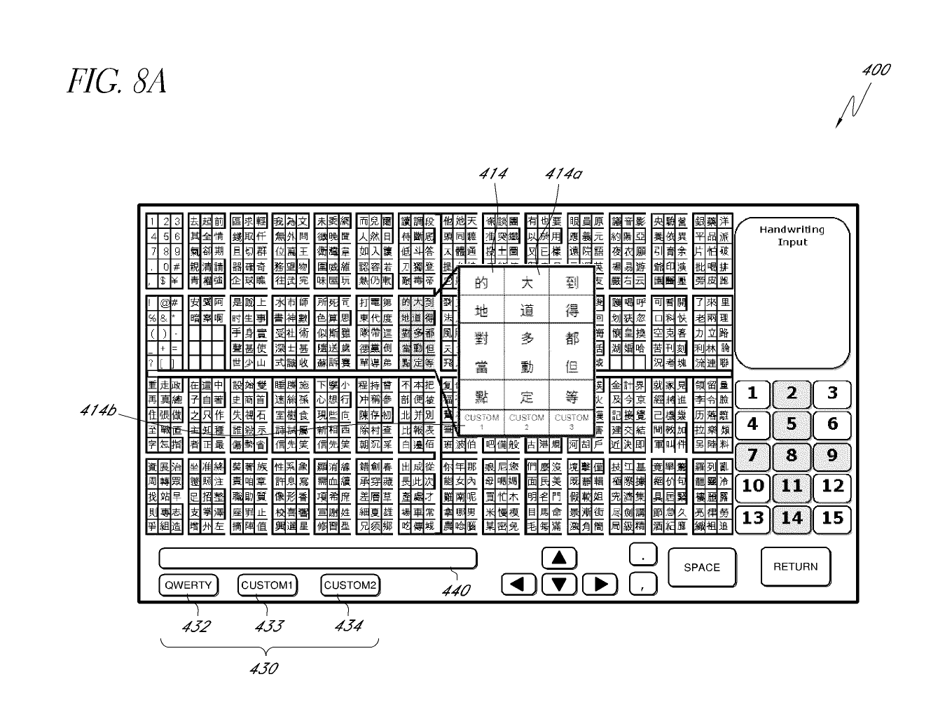

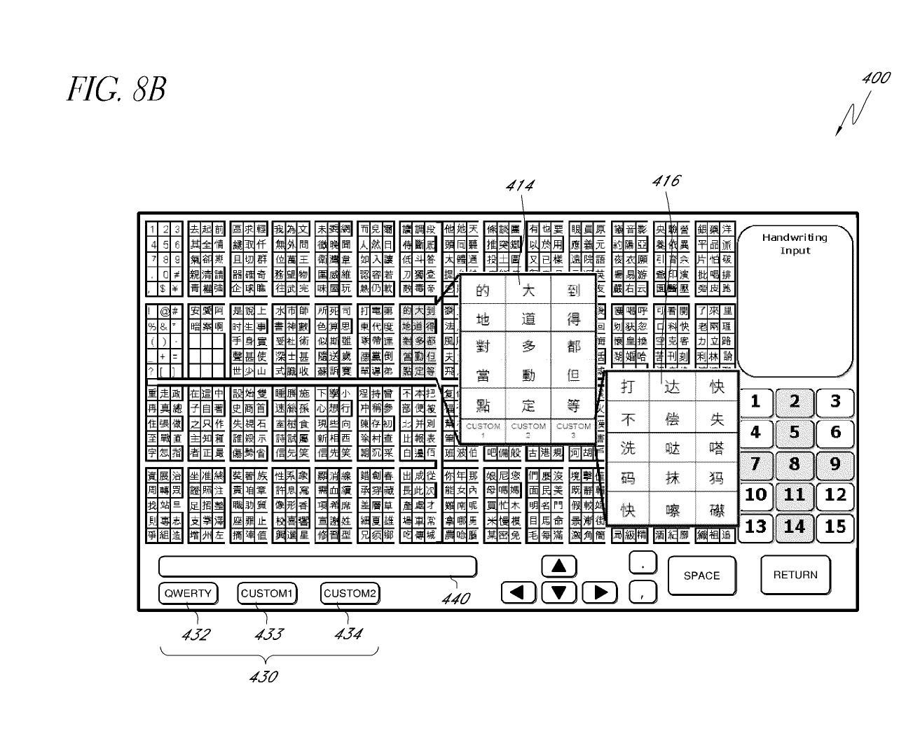

Referring to FIGS. 8A and 8B, a method of inputting a character on one of the additional pages according to one embodiment will be described below. When a character key region is touched, a magnifying window 414 appears on the touchscreen display 210, as shown in FIG. 8A. The magnifying window 414 can include custom page shortcut buttons 414b in addition to characters 414a. A user can access characters on any of the additional pages by touching the desired shortcut button 414b. Then, another magnifying window 416 appears on the touchscreen display 210. The other magnifying window 416 can have the same characters as would be displayed on the corresponding character key region in a similar location on an additional page.

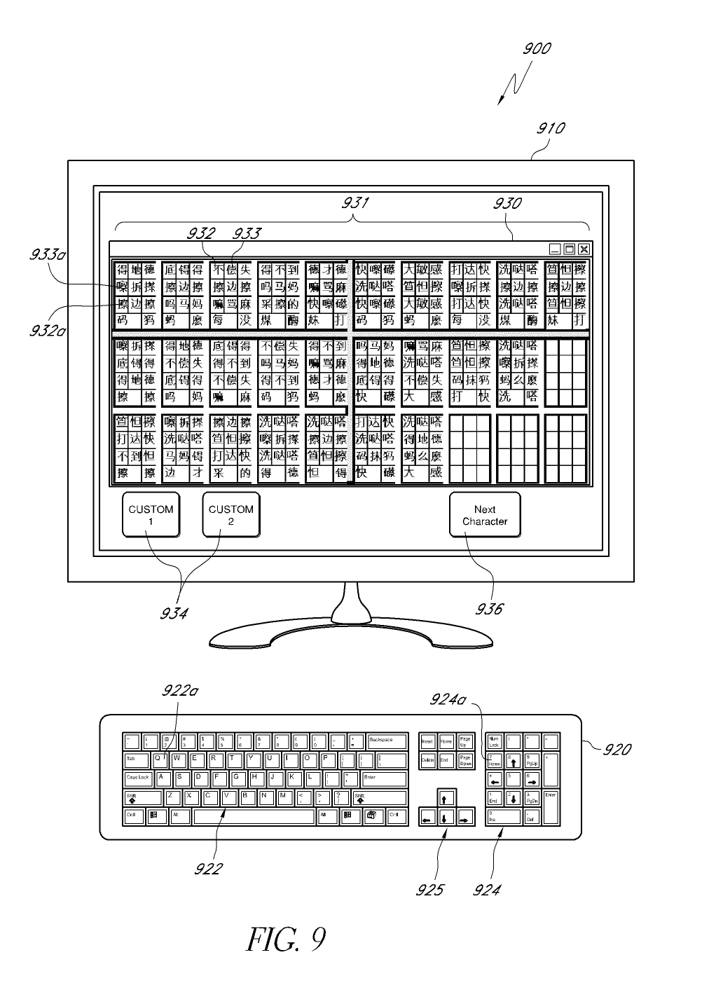

It will be appreciated that the input scheme and display pages described herein can be implemented on non-touchscreen displays. For example, the pages containing characters and associated regions can be shown on a display device and a connected keyboard and/or mouse can be used to make the selections otherwise made by touching the screen. For example, referring to FIG. 9, an input device for a pictographic language, using a conventional computer system, is shown. The illustrated computer system 900 can include a monitor 910, a keyboard 920, and a general purpose computer (not shown). The monitor 910 can be, for example, an LCD monitor or a CRT monitor. The keyboard 920 can be a conventional keyboard, such as a QWERTY keyboard. The computer can be of any suitable type, for example, a desktop computer. In other embodiments, the conventional computer system can be implemented in the form of laptop computer, which includes a monitor and a keyboard integrated with a computer. Thus, the input device 130 can advantageously be implemented as a physical touchscreen keyboard in some embodiments, in some other embodiment the input device for pictographic languages can be a virtual keyboard.

In the illustrated embodiment, a Chinese character input software program displaying a virtual keyboard 930 is provided to implement a Chinese character input device with the computer system 900. The virtual keyboard 930 can be operated using the monitor 910 and the keyboard 920 as a user interface, instead of a touchscreen display. The illustrated virtual keyboard 930 includes a window that displays an array 931 of key regions 932, page selection buttons 934, and a next character selection region 936.

In the illustrated embodiment, the program for the virtual keyboard 930 is stored in a hard disk drive of the computer, and is run when the program is executed by a user. In another embodiment, the virtual keyboard 930 may be stored in a remotely located server that can be connected to the computer, and can be downloaded to and executed by the computer.

The array 931 of key regions includes a plurality of character key regions 932 that are generally arranged in a matrix form. In the illustrated embodiment, the array 931 includes 26 character key regions 932 arranged corresponding to the layout of character keys 922 on the keyboard 920.

Each of the key regions 932 can include a grid including cells 933 arranged in a matrix form. Each of the cells 933 can display one of characters. In the illustrated embodiment, each of the key regions 932 includes 3 columns and 4 rows of cells. The number and arrangement of the cells 933 of the key regions 932 correspond to those of numeric keys 924 on the keyboard 920. The numeric keys 924 can includes separate keys for numbers 0 to 9, and “.”

FIG. 9 only shows a homepage of the virtual keyboard 930. However, the virtual keyboard 930 can include additional pages, as described above in connection with, for example, FIG. 5. Such additional pages can be accessed by clicking on one of the page selection buttons 934. Other details of the homepage and additional pages can be described above in connection with FIGS. 4A-5.

During operation, when a user desires to input the character, the user can locate the character displayed by the virtual keyboard 930. It will be appreciated that the characters are organized based on the first phonetic sounds of the characters. Because characters are grouped into character key regions 932 arranged corresponding to the QWERTY layout, a user who knows how the character is pronounced may locate it based on pronunciation. Once the user has located the key region containing the character, the user can select the key region by striking a key on the keyboard 920 that corresponds to the key region.

For example, if a desired character, for example, [symbol] is in the key region 933a at a first row and a first column (which corresponds to the “Q” key 922a of the keyboard 920), the user can select the key region 933a by striking the “Q” key 922a of the keyboard 920. Then, a magnifying window can appear on the monitor, as described above in connection with FIG. 6. Alternatively, the selected key region 933a can be highlighted or blink.

Then, the user may select the desired character by striking a number key corresponding to the cell containing the desired character. For example, if the desired character, for example, [symbol] is in a cell 933a at the first row and first column of the selected key region 933a, the user can select the character by striking the [symbol] key 924a on the keyboard 920. Alternatively, the desired region and/or character can be selected, using a mouse (not shown), or directional keys 925 and the enter key on the keyboard 920. Other details of selecting characters can be as described earlier in connection with FIG. 6.

In addition, the virtual keyboard 930 can provide a next likely character function as described above in connection with FIGS. 7A-7D. The user can invoke this function by clicking the next character region 936. Alternatively, the function can be automatically invoked when appropriate or when it is set up by the user. When the function is invoked, a desired next character can be selected by using the numeric keys 924 on the keyboard 920, or a mouse or the directional keys 925. Other details of the next likely character function can be as described earlier in connection with FIGS. 7A-7D.

The additional pages provided by the virtual keyboard 930 can also be accessed, as described above in connection with FIGS. 8A and 8B. A desired next character can be selected by using a mouse or the directional keys 925. Other details of accessing the additional pages can be as described earlier in connection with FIGS. 8A and 8B.

The input device 130 and the related systems disclosed herein allow efficient teaching and learning of a pictographic language. By providing completely formed characters on the device, students of language can learn the language without learning to handwrite the characters and without learning a coding system to input the characters. Rather, learning to communicate in the language can largely revolve around gaining familiarity with the characters, as displayed on the input device itself.

In some embodiments, teaching the language can center on teaching the end user (i) the location of the characters on the input device; (ii) recognition of specific characters based on sight; and (iii) how to form grammatically correct sentences. Additionally, the user can be taught to recognize characters by sound.

In some embodiments, a teaching program is used in conjunction with the input device to teach a pictographic language. The teaching program allows a character on the input device to be highlighted and information associated with the character to be provided. The character can be highlighted by simply being selected by the user and/or by changing the appearance of the character to draw attention to it. For example, the character and/or the area immediately around it can change color or shading, the character or the area around immediately around it can blink, the character can light up, the character can be displayed on a displayed to indicate it has been selected, etc. Information regarding the character can be provided before and/or after the character is highlighted.

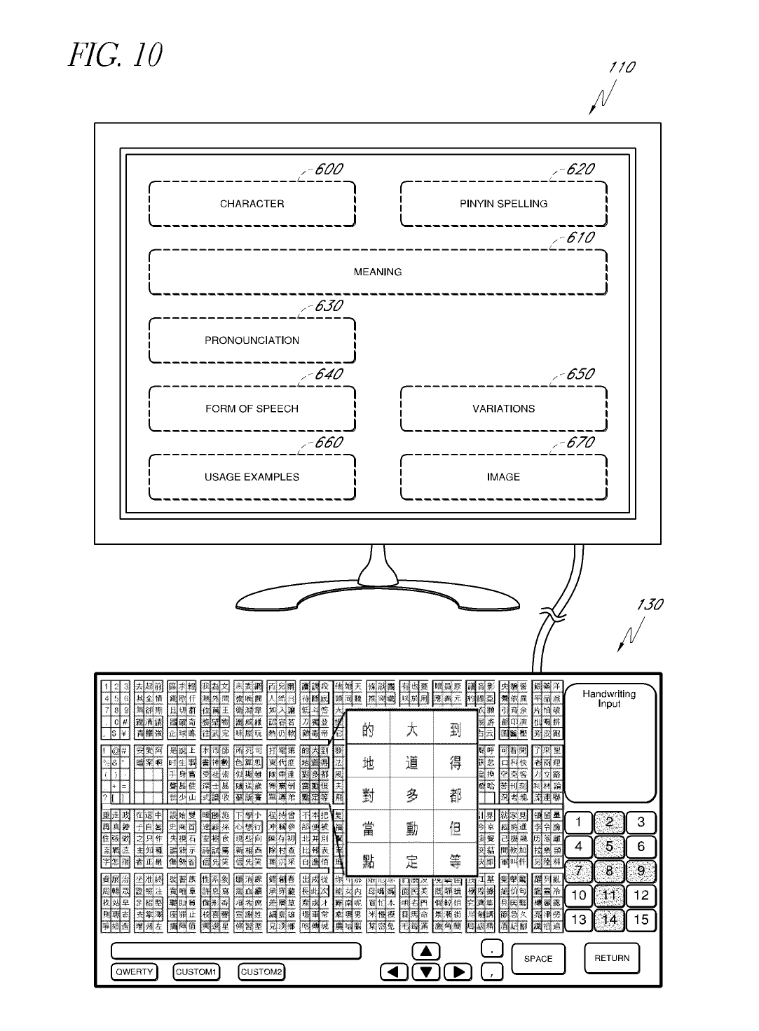

With reference to FIG. 10, the input device 130 can be connected to the display device 110. The input device 130 can be connected directly to the display device 110 (e.g., where the display device 110 includes a computer in the same housing with the display device 110), or can be indirectly connected to the display device 110 (e.g., the input device 130 can be connected to the computer 120 [FIG. 1] which is connected to the display device 130, thereby allowing the input device 130 to electrically communicate with the display device 130). The display device 120 can display information associated with a highlighted character in various display fields. For example, the display device 120 can display, without limitation, a field 600 showing the character (e.g., in traditional or simplified form), a field 610 showing the meaning of the character, a field 620 showing its pinyin spelling, a field 630 with an option to hear the character pronounced, a field 640 showing the form of speech of the character, a field 650 showing the variations in the form of speech (e.g., noun, verb, etc), a field 660 showing the most common usages of the character in phrases or sentences, and a field 670 showing an image of the object denoted by the word if applicable. It will be appreciated that the illustrated screen page provides just an example of an arrangement of fields and other arrangements are possible. For example, the fields may be shown on multiple pages, some fields can be omitted, additional fields may be added, and the relative orientations of the fields can be changed. Where multiple pages are provided, the pages may be navigated using, e.g., user-selectable buttons on the displayed page.

The highlighting and displaying of information regarding a character can be integrated into various teaching methods. For examples, a language can be taught by an “active” or a “traditional” method. The user can select between these methods as desired.

In the active method, the user has the option to select any character he or she chooses from the input device interface. Upon doing so, the display device 120 will display, e.g., the selected Chinese character, its pinyin spelling, a clickable option to hear the character pronounced, the form of speech of the character, variations in the form of speech (e.g., noun forms, verb forms, etc), the most common usages of the character in phrases or sentences, and an image of the word if applicable (e.g., an image of a dog).

It will be appreciated that the active method is particularly advantageous for learning specific characters or for refreshing a user's knowledge regarding a specific character. For example, users already familiar with other characters on the input device 130 can use the active method to learn characters that may be unfamiliar to them. For example, many of the “D-” sound characters are more commonly used than other characters and will be learned sooner than others due to their use in basic conversational speech. Amongst the region containing the D characters on the Home Page are some D characters that are not as common as others. The end user could use the active method to fill in the gaps in his or her understanding so that the entire region becomes familiar.

In the traditional method, the user will follow a lesson plan. The format of the lesson plan is selectable. This allows the lesson plan to be catered to the end user's desired form of learning. The lesson plans can be designed to allow learning groups of characters connected by various themes. For example, the lessons can involve learning characters:
a. one phonetic group at a time;
b. one key region at a time;
c. based on occurrence in common conversational phrases; or
d. based on subject matter (i.e., travel, work, family, animals, sports, etc.).

Learning phonetic groups or specific key regions one at a time can be a systematic approach for users who desire to become familiar with all the characters on the input device. The end user can learn a variety of characters at a time. The characters may not relate to each other but merely are located in the same region on the Home Page. This can allow end users to learn a key region without leaving gaps in their understanding.

For those users who want to learn in a manner that focuses on specific subjects or phrases, the teaching program allows the users to select the types of subjects or phrases they would like to learn. For example, common types of phrases or basis conversational themes can be selected by the user. Once a theme is selected, the teaching program can display a common phrase related to that theme. In addition, the program can display various pieces of information regarding that phrase, including its pinyin pronunciation, its English translation and a list of related phrases in English, which the user can select as the next phrase to be learned. Also, an option is provided for the user to hear the phrase pronounced. The user can learn how to write a basic back-and-forth conversation through this feature. For example, “what is your name?” can be followed with options for learning follow-on phrases such as “my name is ______” or “______, but I go by ______” or “______, but my friends call me ______.” Advantageously, the thematic unity provided by the follow-on phrases can allow users to learn to communicate in basic conservations more quickly than using unrelated phrases.

Similarly, lessons can focus on specific subject matter, which can include, without limitation, travel, work, family, animals, sports, etc. The teaching program allows the user to select the subject matter focus of the lesson. Characters related to that subject can be highlighted, with various pieces of information about the character displayed as discussed above with the active method. The user can also have the option of selecting and learning related characters.

It will be appreciated that the teaching program, whether teaching by the active method or the traditional method, can teaching simply by displaying information regarding a character. For example, selecting a character in the active method can simply result in the displaying of information for the character; or teaching groups of characters in the traditional method can involve simply highlighting particular characters and providing information about those characters individually, in a sequence, or as a group.

In other embodiments, the program can provide interactive exercises that require the user to engage in a back and forth with the computer. In some embodiments, the teaching program can prompt the user for an input, such as displaying a query, and the user is engaged in providing a response, such as selecting a character. For example, the user can be prompted to provide a character for a displayed an image of an object, for a displayed definition, to complete sentences, etc.

Preferably, characters that are being taught are highlighted on the input device. Thus, the locations of characters on the input device can be learned in tandem with learning the meanings and uses of the characters.

It will be appreciated that some students of the language may not be familiar with the spoken form of the language. Advantageously, the organization of the characters of the input device 130 by pronunciation can aid in learning how to pronounce the characters, since the first sound of the character can readily be determined by the character's location, both with reference to the neighboring characters and with reference to the English language letter key to which the character's location is mapped.

It will also be appreciated that the functionality disclosed herein can be provided as part of a computer program. For example, a computer loaded with the programming provided by the program can perform the teaching functions noted herein, including highlighting characters, providing information on characters and carrying out teaching lessons as described herein.

With reference again to FIG. 1, the teaching program can be provided as software on a computer readable medium that can be loaded into the computer 120. It will be appreciated that the computer readable medium can be, e.g., an optical disk (e.g., DVD-ROM, CD-ROM, etc.), a magnetic medium (e.g., a floppy discuss, a hard drive), a charge storage medium (e.g., flash memory), etc. The user can load the program onto the computer 120 by physically loading or connecting the medium to the computer.

In other embodiments, the program can be loaded by downloading the program from a network connection of the computer 120. In some embodiments, the network connection can be a connection to the internet and the program can be downloaded to the computer from the server 125 also connected to the internet. In some other embodiments, the program can be pre-loaded into the input device 130 and the program can be loaded into the computer system 120 upon connection of the input device 130 to the computer 120.

In some embodiments, the server 125 allows users of the program to troubleshoot issues with the program, provide updates, provide additional functionality (e.g., provide additional downloadable “pages” containing characters), answer questions, etc. The server 125 can be run by the provider of the program and accessed, e.g., by accessing a particular website address on the internet.

With reference again to FIG. 9, it will be appreciated that the teaching program can be implemented in conjunction with the “virtual” keyboard 930. For example, the keyboard 930 can be displayed on one display or one part of a display and the information or lessons for the pictographic characters can be displayed on another display or another part of the display. The functions and actions discussed above for the input device 130 can be mimicked on the virtual keyboard 930.

For ease of description, the embodiments above have been described with reference to written Chinese. In other embodiments, the input device can be adapted for other languages that use Chinese characters, for example, Japanese and Korean. In certain embodiments, the input device can also be adapted for any other pictographic language.

In addition, the native language of the user can be any other language. For example, the methods and systems herein can be adapted to teach a pictographic language to a student who has an alphabet-based language as his/her native language. Examples of alphabet-based languages including, without limitation, English, French, Spanish, etc. The methods and systems herein can also be adapted for students having a pictographic language as their native language and wishing to learn another pictographic language. However, for such students, familiarity with the keyboards of an alphabet-based language (e.g., a QWERTY keyboard) is helpful to fully gain the benefits of the organization of the input device 130.

In at least some of the aforesaid embodiments, any element used in an embodiment can interchangeably be used in another embodiment or may be omitted unless such a replacement or omission is not feasible. It will be appreciated by those skilled in the art that various other omissions, additions and modifications may also be made to the methods and structures described above without departing from the scope of the invention. All such modifications and changes are intended to fall within the scope of the invention.

We claim:

1. A method of teaching a pictographic language, comprising:
providing a touchscreen keyboard;
providing a controller programmed to show a first arrangement of pictographic characters on a touchscreen of the touchscreen keyboard, the first arrangement comprising a plurality of characters of the pictographic language, wherein the first arrangement comprises a plurality of discrete regions, each of the regions displaying one group of characters selected from the plurality of characters, each of the regions including characters having a same first phonetic sound;
providing a display in electrical communication with the touchscreen keyboard;
highlighting a character shown on the keyboard; and
displaying information related to the character on the display.

2. The method of claim 1, wherein highlighting the character occurs before displaying information related to the character.

3. The method of claim 2, wherein highlighting the character is preceded by a user selecting the character on the keyboard, thereby causing the character to be highlighted.

4. The method of claim 1, wherein highlighting the character is performed as part of an automated teaching lesson.

5. The method of claim 1, further comprising displaying a query related to a character on the display and soliciting the selection of a character by a user.

6. The method of claim 1, wherein the touchscreen keyboards is a physical keyboard.

7. The method of claim 1, wherein the touchscreen keyboards is a virtual keyboard.

8. A computer readable medium having stored thereon instructions that, when executed, direct a computer system, having a touchscreen keyboard device and a display, to:
show on a touchscreen of the keyboard device a first arrangement comprising a plurality of characters of a pictographic language, wherein the first arrangement comprises a plurality of regions, each of the regions displaying one group of characters selected from the plurality of characters, each of the regions including characters having a same first phonetic sound;
highlight a character on the keyboard; and
display information related to the character on the display.

9. A system for teaching a pictographic language, comprising:
a touchscreen keyboard;
a display in electrical communication with the touchscreen keyboard; and
one or more controllers programmed to:
show a first arrangement of pictographic characters on a touchscreen of the touchscreen keyboard, the first arrangement comprising a plurality of characters of the pictographic language, wherein the first arrangement comprises a plurality of discrete regions, each of the regions displaying one group of characters selected from the plurality of characters, each of the regions including characters having a same first phonetic sound;
highlight a character shown on the keyboard; and
display information related to the character on the display.

10. The system of claim 9, wherein the one or more controllers are provided in a computer forming part of the system.

11. The system of claim 9, wherein a touchscreen controller provided on the keyboard contains programming to show a first arrangement of pictographic characters on a touchscreen of the touchscreen keyboard, the first arrangement comprising a plurality of characters of the pictographic language, wherein the first arrangement comprises a plurality of discrete regions, each of the regions displaying one group of characters selected from the plurality of characters, each of the regions including characters having a same first phonetic sound.

12. The system of claim 9, wherein the system further comprises a computer in electrical communication with the touchscreen keyboard and the display, wherein controllers in the computer are programmed to highlight a character shown on the keyboard; and to display information related to the character on the display.
